(19) United States
(12) Patent Application Publication
(10) Pub. No.: US 2018/0375994 A1
(43) Pub. Date: Dec. 27, 2018

(54) METHOD FOR MANAGING AT LEAST ONE COMMUNICATION, CORRESPONDING DEVICE AND SOFTWARE MODULE PROGRAM

(71) Applicant: Orange, Paris (FR)

(72) Inventors: Yann Gestraud, Rennes (FR); Jean-Francois Gyss, Rospez (FR); Marc Bailly, Trebeurden (FR)

(21) Appl. No.: 16/063,211

(22) PCT Filed: Dec. 13, 2016
(86) PCT No.: PCT/FR2016/053355

§ 371 Date: Jun. 15, 2018

(30) Foreign Application Priority Data
Dec. 17, 2015 (FR) 1562702

(51) Int. Cl. H04M 3/436; H04L 29/06; H04W 12/02; H04L 12/66

(52) U.S. Cl. CPC H04M 3/4365; H04L 63/205; H04M 2203/6009; H04L 12/66; H04L 69/24; H04W 12/02

(57) ABSTRACT

A method is provided for managing at least one communication between a first communication hardware and at least a second communication hardware, used respectively on separate communication networks, respectively managed by a first communication management device and at least a second communication management device. The method can be implemented by the first communication management device and can include obtaining at least one risk indicator of non-compliance with the confidentiality of data associated with the at least one communication, and transmitting the at least one risk indicator to the first item of communication hardware.

### 1. FIELD OF THE INVENTION

The field of the invention is that of multimedia telecommunications, such as voice communications between users, the exchange of text messages, such as video or the exchange of files.

More specifically, the present application relates to enriched interpersonal communications between two users, who are respectively contracted to telecommunications operators providing access to separate networks, and who communicate by means of a platform which offers, regardless of the type of network, communication services such as instant messaging or chat, status information, voice and video communication (or “live” video) and file sharing.

### 2. PRIOR ART

The arrival of smartphones and the development of over-the-top (OTT) mobile applications and services, which are independent of operators, such as Viber®, Whatsapp® or Skype®, also offer new communication services which are adapted to their customers' requirements.

It is in this context that the mobile telephony standard for rich communication service (RCS) was established in 2012 on the initiative of the GSM Association (GSMA).

More specifically, the RCS standard relates to the deployment of an interoperable communication system, i.e. a system which operates regardless of the telecommunications network operator who has deployed the service and on any telephone device which is compatible with this RCS standard.

The new functions proposed under the RCS standard primarily relate to messages and calls, and are intended to provide mobile telephone access to services which are currently provided by social networks and existing instant messaging facilities (i.e. over-the-top (OTT) services, which are independent of operators).

The RCS standard thus permits conventional telephony, but also provides access to similar services to those delivered by OTT facilities, using a single identifier (the telephone number).

In terms of rich messaging, the RCS standard permits, via a dedicated RCS platform, the deployment of instant messaging (or chat) between users, the option for the sending of files and the creation of instant chat groups. In terms of enriched calling, the RCS standard permits the sharing of videos, messages, location or files while a call is in progress. Thus, for example, it is possible to superimpose a video chat window on another application which is currently running.

Moreover, the RCS standard provides for an enriched address book which includes, in addition to customary contact information, i.e. telephone number, identity, address, etc., additional information which permits users to share the following: their status (available or busy), a mood message (status), a photograph or a favorite web link, and which can be automatically synchronized on the telephone devices of users who share their “profile”, or their contact record. Specifically, these contacts can be hosted by an operator other than that of the user who transmits the messages.

It should be noted, however, that the infrastructure associated with the RCS standard, namely the platform for the delivery of the communication service and the corresponding dedicated servers, are not deployed and managed by a single telecommunication network operator, but by all the operators who subscribe to this standard.

Each operator is free to define, for example, the maximum size of messages which it permits on its network, the nature of these messages, images, videos, music files, contact records, locations, files, etc.

Thus, the rules for the use of services delivered by the RCS platform, and the associated rules of confidentiality, differ from one telecommunications network operator to another, or from one service provider using this RCS platform to another.

More specifically, interpersonal communications under the RCS standard are established by means of sessions in accordance with the standard SIP communication protocol (“Session Initiation Protocol”). Beforehand, or during the establishment of the SIP session, a capacity exchange between the telephone devices of at least two users who are respectively contracted to telecommunications operators providing access to separate networks is executed in order to confirm that a user of the device which is to receive the communication has the capacity to process the type of communication initiated by the transmitting device.

At present, however, there is no satisfactory solution which can guarantee that the user will incur no risk when they communicate with a user who is contracted to a different operator from their own.

Just because the user's own operator guarantees to them that the content of their communications will not be exploited for commercial purposes, this does not mean that the operator of the recipient of these communications will observe the same guarantees.

There is consequently a need for new enriched interpersonal communication techniques which permit the more effective protection of the confidential information of a user by alerting the latter to risks incurred.

### 3. PRESENTATION OF THE INVENTION

The invention proposes a novel solution, which does not feature this drawback from the prior art, in the form of a method for managing at least one communication between a first and at least one second communication apparatus used respectively on separate communication networks, managed respectively by a first and at least one second communication management device.

Specifically, the method comprises the following steps, deployed by the first communication management device:
acquisition of at least one risk indicator for non-compliance with the confidentiality of data associated with the communication,
transmission of the risk indicator to the first communication apparatus.

The present application thus proposes the improvement of enriched interpersonal communication techniques.

In effect, the present application permits the user of the first apparatus to be alerted to the risk of non-compliance with the confidentiality of the content of their communication which they incur when they establish a communication with the user of the second communication apparatus.

Such a risk of non-compliance with the confidentiality of data associated with their communication specifically corresponds to a risk of exploitation, for commercial purposes, of the content of the communication and of the personal information of the user, such as their contact record, including their contact details or their business.

Such exploitation of the data of a user for commercial purposes is not committed by their own service provider or their own operator, who undertakes to observe the confidentiality of their data, but by third parties associated with the operator of their contact person and/or directly by the operator of their contact person.

It should be noted that the risk indicator according to the present invention may be transmitted for each communication, or for a group of communications corresponding to a predetermined time period defined by the user or by the operator or the service provider, or periodically at a predetermined frequency defined by the user or by the operator or the service provider.

According to a particular aspect of the present application, said at least one communication corresponds to an enriched interpersonal communication according to the RCS® communication standard.

It should be noted that, by extension, the RCS® communication standard encompasses SMS (“Short Message Service”) and MMS (“Multimedia Message Service”) messaging services for the exchange of written messages or enriched text messages.

This type of communication according to the RCS® standard makes it possible to offer numerous functionalities to the user, who then no longer needs to use existing instant messaging facilities (i.e. over-the-top (OTT) services, which are independent of operators) in order to access similar functionalities.

According to one aspect of the present application, the steps for the acquisition and transmission of said at least one risk indicator are deployed by the first communication management device during an exchange phase with said at least one second communication management device,

the exchange phase comprising at least the following steps, deployed by said first communication management device for said at least one communication:
reception of a capacity request from said at least one second communication apparatus, the capacity request being transmitted by the first communication apparatus,
transmission of the capacity request to said at least one second communication management device,
reception of representative information for the capacity of said at least one second communication apparatus, transmitted by said at least one second communication management device.

In other words, according to this aspect of the present application, the conventional mechanism for the exchange of capacities is expanded to include the acquisition of a risk indicator for the exploitation of data associated with the communication by the service provider of the operator of the second network or a third party/partner of this operator.

According to a particular characteristic, the representative information for the capacity of said at least one second communication apparatus and said at least one risk indicator are transmitted in the same signal to the first communication apparatus.

This particular characteristic permits the mutualization of a transmission for the transmission of both the risk indicator and the representative information for the capacity, rather than the deployment of one transmission of the representative information for the capacity and another transmission of the risk indicator.

However, it should be noted that, according to a further variant of the present application, the deployment of two separate transmissions, dedicated respectively to the representative information for the capacity on the one hand and to the transmission of the risk indicator on the other, are possible.

According to a further characteristic, the transmission of the capacity request is deployed before or during the establishment of said at least one communication.

Thus, various modes of capacity exchange can be deployed, either prior to the establishment of the communication according to a SIP OPTIONS (“Session Initiation Protocol”) or Presence SIMPLE communication protocol, or during the establishment of the communication by means of an SDP negotiation (“Session Description Protocol”).

According to a further characteristic of the present application, the type of said at least one risk indicator is formatted by the first communication management device as a function of the type of communication.

In other words, if the type of communication is, for example, a text communication, the type of risk indicator will be adapted to the user interface employed on the first apparatus for the deployment of this type of communication, and will correspond to a text message of chat/SMS type.

According to a further example, in the context of a video communication, the type of the risk indicator will correspond to a video element (sound and/or image) which will alert the user.

In a similar manner, in a context of an exclusively audio communication, the type of the risk indicator corresponds, for example, to a vocal announcement.

It should also be noted that the risk indicator according to the present application can comprise a hyperlink or an access request which, once activated by the user, permits the latter to access a more detailed report on the risk which they incur, this report also being able to be downloaded by activating the hyperlink (or the access request) indicated within the risk indicator.

Thus, it should be noted that the risk indicator will preferably be of a small and predetermined size (several bytes or several hundred bytes, depending on the communication protocol employed), in order to prevent any overloading of the passband.

According to a further characteristic of the present application, said at least one risk indicator is transmitted, at the request of the first communication management device, by:
said at least one second communication management device, and/or
a database which is independent of said at least one second communication management device, the database storing, respectively for a plurality of separate operators or service providers comprising one operator or one service provider associated with said at least one second communication management device, information on the risk of non-compliance with the confidentiality of communication data.

In other words, the risk indicator may be delivered directly, according to a declarative confidence level, by the second communication management device or, alternatively, by at least one database which is queried by the first device.

Moreover, it is possible for both alternatives to be deployed, and for the two risk indicators obtained to be transmitted, as they stand, to the first communication apparatus.

It is also possible for both alternatives to be deployed, and for only one risk indicator to be transmitted to the first communication apparatus, corresponding to a combination (i.e. a re-writing/adaptation of the indicator delivered by the second communication management device) of the two risk indicators obtained, this combination being able to incorporate a weighting which favors the source corresponding to the device or the source corresponding to the independent database.

According to a further aspect of the present application, said at least one risk indicator is transmitted, at the request of the first communication management device, by the database, independently of said at least one communication.

Such a characteristic permits, for example, the consultation of the database on request and the transmission to the first apparatus of the risk indicator in order, for example, to enrich the contact record associated with the second apparatus contained therein, such that the associated risk appears directly on the contact record and is updated when the database is updated, independently of the establishment of a communication and of the exchange of capacity associated with this establishment.

According to a further aspect of the application, said at least one risk indicator is transmitted automatically when an update of the database is executed.

The present application also relates to a signal for managing at least one communication between a first and at least one second communication apparatus used respectively on separate communication networks, managed respectively by a first and at least one second communication management device.

According to the present application, such a signal is transmitted during an exchange phase with said at least one second communication management device, and comprises representative information for the capacity of said at least one second communication apparatus and at least one risk indicator for non-compliance, by said at least one second communication management device, with the confidentiality of data associated with said at least one communication.

In other words, according to this particular aspect, which is deployed during a capacity exchange phase between the first and second communication apparatuses, the transmission of the risk indicator is executed mutually with the representative information for the capacity of said at least one second communication apparatus, within the same signal.

However, according to a further aspect, as indicated above, it is possible for the risk indicator to be transmitted to the first apparatus independently of the capacity exchange phase or of the communication.

The present application also relates to a device for managing at least one communication between a first and at least one second communication apparatus used respectively on separate communication networks, managed respectively by the management device and at least one second communication management device.

According to the present application, such a device for managing at least one communication comprises:
a module for the acquisition of at least one risk indicator for non-compliance with the confidentiality of data associated with said at least one communication,
a module for the transmission of said at least one risk indicator to the first communication apparatus.

Such a device for managing at least one communication is specifically adapted for the deployment of the above-mentioned method for managing at least one communication. This is, for example, a communication server or a capacity server (specifically when the steps for the acquisition and transmission according to the above-mentioned method are deployed during a capacity exchange phase), respectively associated with a telecommunications network operator or with a service provider.

The device can of course incorporate the various characteristics relating to the method for managing at least one communication according to the present application. The characteristics and advantages of this device are thus the same as those of the management method according to the present application, and are not described in greater detail.

The present application also relates to a communication apparatus which is capable of receiving and processing the risk indicator transmitted by a communication management device as described above.

A further aspect of the present application relates to a software module program incorporating software module program code instructions for the execution of the steps of the method for managing at least one communication according to the present application when the program is run on a computer.

The object of the present application can thus be implemented in various manners, specifically in the form of apparatus or software.

### 4. LIST OF FIGURES

Further characteristics and advantages of the object of the present application will be clarified on reading the following description of a particular form of embodiment, which is provided by way of illustrative example only and not by way of limitation, and the attached drawings, in which:

FIG. 1 represents the key steps in a method for managing at least one communication according to one form of embodiment of the invention,

FIG. 2 represents a further form of embodiment of a method for managing at least one communication according to the invention,

FIG. 3 illustrates the deployment of a method for managing at least one communication according to FIG. 1 or FIG. 2,

FIG. 4 represents the structure of a management device according to a particular form of embodiment of the invention,

FIG. 5 represents the structure of a communication apparatus according to a particular form of embodiment of the invention.

### 5. DESCRIPTION OF ONE FORM OF EMBODIMENT OF THE INVENTION

The general principle of the invention is based upon the delivery, to a user, of a risk indicator for the exploitation of the personal data of this user, associated with a communication, by the operator or the service provider of the recipient of the communication.

In other words, for a user who is concerned about the non-exploitation of their personal data by third parties and/or by their service provider, the present application provides a solution which permits the determination of whether, according to their contact person, these rules of non-exploitation are also respected by the operator or the service provider of their contact person.

More specifically, the present application proposes that such an alert be delivered, to the user (via their communication apparatus), by a communication management device which manages the establishment of the communications of this user.

It should be noted that the general principle according to the invention can easily be extended to the cause of the communication between two contact people, in the event that a communication is simultaneously established with a plurality of contact people, in which case one risk indicator per contact person would be obtained and transmitted to the user of the first apparatus U1.

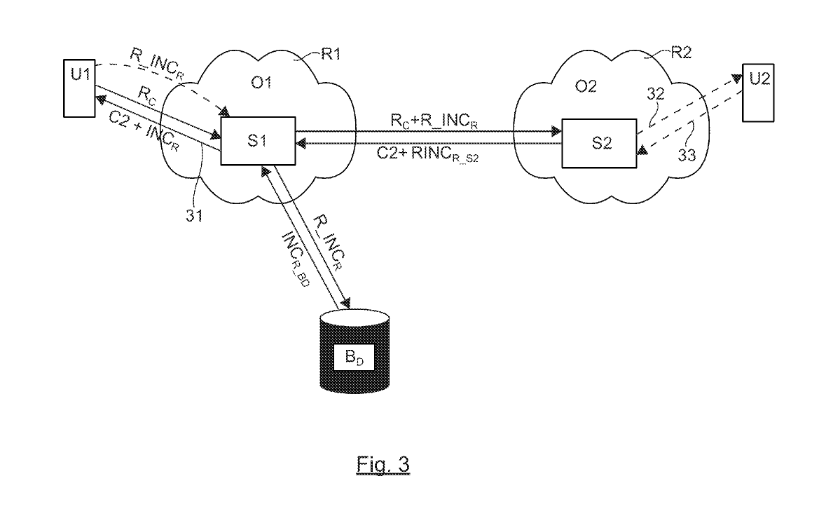

An exemplary deployment of the object of the present application is described hereinafter, in the context of the deployment of enriched interpersonal communications between a first and at least one second communication apparatus U1 and U2 used respectively on separate communication networks R1 and R2, managed respectively by a first S1 and at least one second S2 communication management device, as illustrated in FIG. 3.

According to a particular aspect, the type of communication managed according to the present application is an enriched interpersonal communication according to the RCS® communication standard, as described above.

With reference to FIG. 1, the key steps deployed by a method for managing at least one communication according to one form of embodiment of the invention are described. These different steps are deployed, for example, in a communication management device S1 as represented in FIG. 3.

Thus, the present application principally deploys the following two steps: firstly, the acquisition (11) of at least one risk indicator INC_{R} for non-compliance, by the second communication management device S2, with the confidentiality of data associated with said at least one communication, and secondly the transmission (13) of the risk indicator to the first communication apparatus U1.

Specifically, according to a first form of embodiment, the risk indicator INC_{R} is transmitted by the second communication management device S2.

In other words, the risk indicator INC_{R}_{_}_{S2} is delivered directly, according to a declarative confidence level, by the second communication management device S2.

Where applicable (32, 33), the second device S2 queries the second apparatus U2, or the user of the second apparatus via this second apparatus U2, in order to obtain INC_{R}_{_}_{S2}, which it then resends to the first communication management device S1.

Thus, according to this first form of embodiment, the user of the first communication apparatus U1 transmits, to the first communication management device S1, on which it depends, a risk indicator query R_INC_{R} associated with the contact person in possession of the second apparatus U2.

The first communication management device S1 resends this risk indicator query R_INC_{R} to the second communication management device S2, and receives (11) from the latter the risk indicator INC_{R}_{_}_{S2}=YES, which it then transmits (13) to U1.

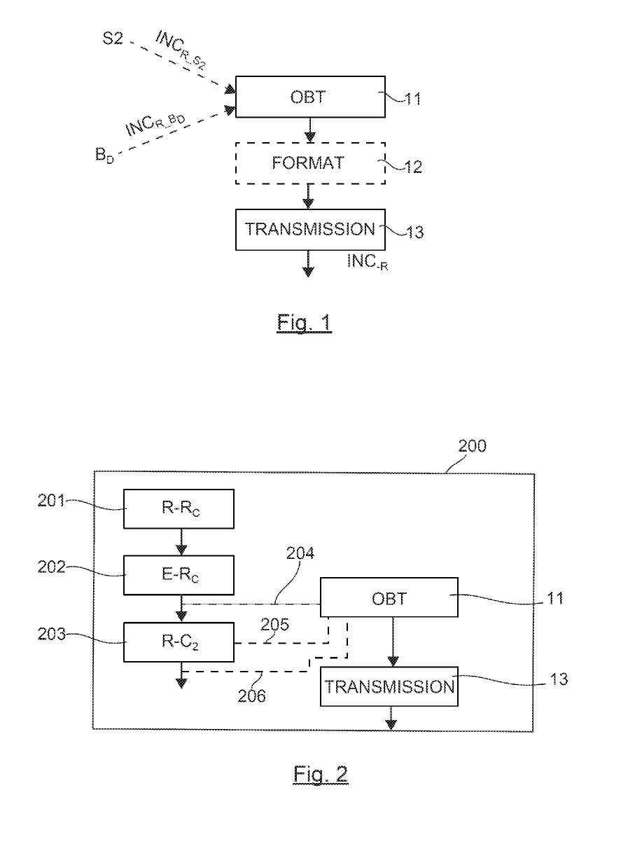

According to a particular aspect of this first form of embodiment, as illustrated in FIG. 2, said steps for the acquisition (11) and transmission (13) of the risk indicator are deployed by the first communication management device S1 during an exchange phase (200) with the second communication management device S2.

More specifically, the exchange phase (200) comprises at least the following steps, deployed by the first communication management device S1:
reception (201) of a capacity request Rc from the second communication apparatus U2, the capacity request Rc being transmitted by the first communication apparatus U1,
transmission (202) of the capacity request Rc to the second communication management device S2,
reception (203) of representative information for the capacity C2 of the second communication apparatus U2, transmitted by the second communication management device S2 (either directly by the second communication management device S2 or by the second communication apparatus U2 via the second communication management device S2).

Thus, according to this particular aspect, as represented in FIG. 2, the conventional mechanism for capacity exchange between two communication apparatuses U1 and U2 establishing a communication is extended such that it simultaneously comprises the management of the risk indicator INC_{R} for non-compliance with the confidentiality of data associated with said at least one communication.

In this particular case, the risk indicator INC_{R}_{_}_{S2} is processed as an additional capacity associated with the communication apparatus U2.

It should be noted that the acquisition (11) of the risk indicator INC_{R}_{_}_{S2} may be deployed preliminarily (204), simultaneously (205) or successively (206) to the step for the reception (203) of representative information for the capacity C2 of the second communication apparatus U2.

Moreover, it should be noted that the transmission (202) of the capacity request Rc is deployed before or during the establishment of the communication.

Thus, various modes of capacity exchange can be deployed, either prior to the establishment of the communication according to a SIP OPTIONS (where the response 200 OK to the request Rc contains a list of tags, each of which defines a capacity of the second communication apparatus U2) or Presence SIMPLE (where the response to the presence request Rc contains the list of services supported by U2) communication protocol, or during the establishment of the communication by means of an SDP negotiation during the establishment of the SIP session, which permits the exchange of capacity information upon the start-up of the conversation between users.

It should be noted that this first form of embodiment is preferably deployed when the operator O2 or the service provider associated with the second communication management device S2 is “transparent” (i.e. is trusted by definition).

According to a second form of embodiment, the risk indicator INC_{R}_{_}_{BD} is acquired (11) exclusively from the database B_{D}, independently of the second communication management device S2.

Such an acquisition (11) is deployed, for example, independently of the establishment of a communication (e.g. audio telephone service) when the user of the first apparatus U1 wishes to employ the object of the present application for the expansion of their contact list, without establishing a communication per se.

More specifically, such a database B_{D} stores, respectively for a plurality of separate operators or service providers comprising one operator or one service provider associated with the second communication management device S2, information on the risk of non-compliance with the confidentiality of communication data.

For example, such storage may be executed in the form of a list, in which one operator or service provider is paired with an exploitation risk.

An exemplary list is specifically illustrated by the table below, with reference to the exemplary deployment in FIG. 3:

| Operator/service provider | Exploitation risk |
|---|---|
| O1 | NO |
| O2 | YES |
| . . . | . . . |

According to a first alternative, such a database B_{D} is, for example, associated with the first communication management device S1. In other words, for example, the following exist:
a link of physical dependence (the database is physically and materially integrated in the server S1),
or a commercial/ownership link, the database B_{D} is affiliated, like the first device S1, to the same operator O1.

In this case, the risk indicator INC_{R}_{_}_{BD} delivered by the database B_{D} corresponds to an evaluation, associated with the operator O1 with which the first communication management device S1 is associated, of non-compliance with the confidentiality of the personal data of the user of the first communication apparatus U1.

According to a second alternative, the database B_{D} is independent of the first communication management device S1 and is, for example, delivered by a trusted third party, who is certified, for example, by a regulator of the operator market.

In this case, the risk indicator INC_{R}_{_}_{BD} delivered by the database B_{D} corresponds to an evaluation, objectively guaranteed by a third party, of non-compliance with the confidentiality of the personal data of the user of the first communication apparatus U1.

Thus, according to this second form of embodiment, the user of the first communication apparatus U1 transmits, to the first communication management device S1, on which it depends, a risk indicator request R_INC_{R} associated with the contact person in possession of the second apparatus U2.

The first communication management device S1 resends this risk indicator request R_INC_{R} to the database B_{D} and receives (11), for example, from the latter the binary risk indicator INC_{R}_{_}_{BD}=YES, which it then transmits (12) to U1 (for example in the form of a binary value 0).

In consideration of this binary risk indicator INC_{R}_{_}_{BD}=YES, the user of the first apparatus U1 can enrich the contact record associated with the user of the second apparatus U2 by adding this information in the form of a field in the contact record, or can block this contact if the user wishes to prevent any subsequent communication with this contact person.

According to a particular and optional form of embodiment, a apparatus U1 receiving such a binary risk indicator INC_{R}_{_}_{BD}=YES, corresponding to a proven risk of exploitation of the personal data of its user, could automatically activate (i.e. with no intervention by the user) the blocking of the establishment of communications (i.e. data exchanges) with the contact person in possession of the second apparatus U2. Conversely, in the case of the reception of a binary risk indicator INC_{R}_{_}_{BD}=NO (transmitted, for example, in the form of a binary value 1), the apparatus U1 would automatically unblock the contact person in possession of the second apparatus U2, if the latter has been blocked, or would continue to authorize the establishment of communications between the two apparatuses U1 and U2.

According to a further variant of this second form of embodiment, where the risk indicator INC_{R}_{_}_{BD} is acquired (11) exclusively from the database B_{D}, independently of the establishment of a communication, the risk indicator INC_{R}_{_}_{BD} is not acquired (11) at the request of the management device S1, but is transmitted automatically by the database (B_{D}) in the event of the updating of the latter.

According to a third form of embodiment, the above-mentioned first and second forms of embodiment are combined, as represented in FIG. 3.

Specifically, according to the combination of these two modes, as represented in FIG. 3, the acquisition and the transmission of the risk indicator are optionally deployed during the capacity exchange phase (200) described above in relation to the first form of embodiment.

Specifically, as represented by the broken lines, according to this third form of embodiment, the first apparatus U1 does not systematically deploy a risk indicator request R_INC_{R} to the first communication management device S1.

In effect, according to one characteristic of embodiment, as soon as the first communication management device S1 receives a capacity request Rc from U1, it then transmits, entirely independently, a risk indicator request R_INC_{R} to the second communication management device S2 and to the database B_{D}.

According to this third form of embodiment, the first communication management device S1 receives two risk indicators INC_{R}_{_}_{S2} and INC_{R}_{_}_{BD} (simultaneously or otherwise) originating respectively from the second communication management device S2 and from the database B_{D} which is independent of the second communication management device S2. According to a first alternative, the first communication management device S1 resends this information in the form of a pair INC_{R} (INC_{R}_{_}_{S2}, INC_{R}_{_}_{BD}) to the first communication apparatus U1. In this case, it is the user of this first apparatus U1 who will analyze these two items of information originating respectively from the operator O2 or from the service provider associated with the second communication apparatus U2 (according to a declarative confidence level, relative to the transparency of “O2”) and from the database B_{D} (according to a confidence level associated with the operator O1 of the communication apparatus U1, or a confidence level which is guaranteed by an independent third party when the database B_{D} is independent of the operators O1 and O2).

According to a second alternative, the first communication management device S1 combines these two indicators INC_{R}_{_}_{S2} and INC_{R}_{_}_{BD}.

Such a combination can optionally comprise a weighting which favors the risk indicator source corresponding to the device or the risk indicator source corresponding to the independent database, for example in the form: INC_{R}=a. INC_{R}_{_}_{S2}+b. INC_{R}_{_}_{BD}, where a and b are weighting parameters between 0 and 1. Thus, according to this alternative, the value of the risk indicator corresponds, for example, to a percentage, a whole number value, a value between 0 and 1, etc.

According to a particular characteristic illustrated in FIG. 3, the representative information for the capacity C2 of the second communication apparatus U2 and the risk indicator INC_{R} are transmitted in the same communication signal (31) to the first communication apparatus U1, in order to mutualize their transmission.

In any of the three forms of embodiment described above, once the risk indicator INC_{R} has been acquired (11) from the second communication management device S2 and/or from the database (B_{D}), the first communication management device S1 optionally deploys (as represented by the broken lines in FIG. 1) a step for the formatting (12), encoding (e.g. in binary form) or re-writing of the risk indicator INC_{R}, as a function of the type of communication deployed between the two communication apparatuses U1 and U2.

Such formatting (12) corresponds, for example, to the conversion of the risk indicator INC_{R} into data which, once displayed on the first communication apparatus U1, will correspond to an icon or a warning message, in order to alert the user of the first communication apparatus U1 to the risk of exploitation of the potential forthcoming communication for commercial purposes.

Alternatively, in the context of a text communication, such formatting (12) will involve the conversion of the risk indicator INC_{R} into a message of chat/SMS type indicating to them that the conversation being initiated is liable to be exploited for commercial purposes.

Alternatively, in the context of a video communication, such formatting (12) will involve the conversion of the risk indicator INC_{R} into a message indicating that the conversation being initiated is liable to be exploited for commercial purposes.

Alternatively, in the context of an audio communication, such formatting (12) will involve the conversion of the risk indicator INC_{R} into a voice announcement or a specific sound indicating that the conversation being initiated is liable to be exploited for commercial purposes.

Alternatively, such formatting (12) will involve the conversion of the risk indicator INC_{R} into a signal for the blocking of the establishment of this type of communication with the user of the second communication apparatus U2, if this is the preference of the user of the first communication apparatus U1.

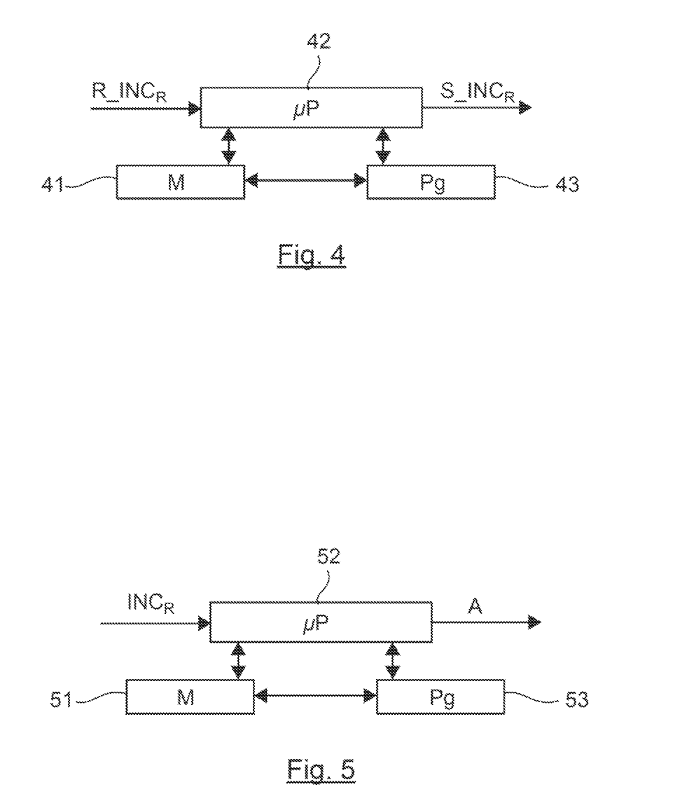

Finally, with reference to FIG. 4, the simplified structure of a communication management device is presented, deploying a communication management technique according to the forms of embodiment described above.

Such a communication management device comprises a memory 41, comprising a buffer memory, a processing unit 42, equipped, for example, with a microprocessor μP, and controlled by the computer program 43, deploying the communication management method according to the invention.

Upon initialization, the instructions of the computer program code 43 are, for example, loaded in a RAM memory, before being executed by the processor of the processing unit 42. The processing unit 42 receives, as an input, a request R_INC_{R} for the establishment of communication or the execution of a query of the database B_{D} (transmitted by a communication apparatus U1 or by the database itself which, in the event of an update, indicates to the communication management device S1 that it is available for a further query). The microprocessor of the processing unit 42 deploys the steps of the communication management method described above, according to the instructions of the computer program 43, in order to alert the user of the communication apparatus U1 to the risk that they incur when they communicate with a user who is contracted to an operator, associated with at least one second communication management device S2, which is different from their own. To this end, the management device comprises, in addition to the buffer memory 41, a module for the acquisition of at least one risk indicator for non-compliance, by said at least one second communication management device S2, with the confidentiality of data associated with said at least one communication, and a module for the transmission of said at least one risk indicator to said first communication apparatus U1. These modules are controlled by the microprocessor of the processing unit 42.

Finally, with reference to FIG. 5, the simplified structure of a communication apparatus (U1) is presented, managed by a communication management device (S1), illustrated in FIG. 4, and deploying the communication management technique according to the forms of embodiment described above.

Such a communication apparatus (U1) comprises a memory 51, comprising a buffer memory, a processing unit 52, equipped, for example, with a microprocessor μP, and controlled by the computer program 53, deploying the communication management method according to the invention.

Upon initialization, the instructions of the computer program code 53 are, for example, loaded in a RAM memory, before being executed by the processor of the processing unit 52. The processing unit 52 receives, as an input, a risk indicator INC_{R} alerting (A) the user of the communication apparatus (U1) to the risk that they incur when they communicate with a user who is contracted to an operator, associated with at least one second communication management device S2. The microprocessor of the processing unit 52 processes this risk indicator INC_{R}, according to the instructions of the computer program 53, in order to alert and protect, in consideration of the risk indicated, the user of the communication apparatus U1 when they communicate with a user who is contracted to an operator which is different from their own. To this end, the communication apparatus comprises, in addition to the buffer memory 51, a module for the reception and processing of at least one risk indicator for non-compliance, by said at least one second communication management device S2, with the confidentiality of data associated with said at least one communication.

According to a particular form of embodiment, the reception and processing module is activated during an exchange phase with the second communication management device (S2), and receives a signal comprising representative information for the capacity of the second communication apparatus (U2) and a risk indicator for non-compliance, by the second communication management device (S2), with the confidentiality of data associated with said at least one communication.

According to a further form of embodiment, the communication apparatus also comprises a module for the blocking and/or unblocking of the establishment of communication with the second communication apparatus, the blocking and/or unblocking module being activated as a function of the value of the risk indicator. These modules are controlled by the microprocessor of the processing unit 52.

1. A method for managing at least one communication between a first communication apparatus and at least one second communication apparatus, used respectively on separate communication networks, managed respectively by a first communication management device and at least one second communication management device, the method deployed by said first communication management device and comprising:
acquiring at least one risk indicator for non-compliance with the confidentiality of data associated with the at least one communication; and
transmitting the at least one risk indicator to the first communication apparatus.

2. The method of claim 1, wherein the at least one communication corresponds to an enriched interpersonal communication according to the RCS® communication standard.

3. The method of claim 1, wherein the first communication management device acquires the at least one risk indicator and transmits the at least one risk indicator during an exchange phase with the at least one second communication management device, and wherein the exchange phase comprises at least the following steps, deployed by the first communication management device for the at least one communication:
receiving a capacity request from the at least one second communication apparatus, the capacity request being transmitted by the first communication apparatus,
transmitting the capacity request to the at least one second communication management device,
receiving representative information for the capacity of the at least one second communication apparatus, transmitted by the at least one second communication management device.

4. The method of claim 3, wherein the representative information for the capacity of the at least one second communication apparatus and the at least one risk indicator are transmitted in the same signal to said first communication apparatus.

5. The method of claim 3, the capacity request is deployed before or during the establishment of the at least one communication.

6. The method of claim 1, wherein the type of the at least one risk indicator is formatted by the first communication management device as a function of the type of the communication.

7. The method of claim 1, wherein the first communication management device (requests the transmission of the at least one risk indicator, by:
the at least one second communication management device, and/or
a database which is independent of the at least one second communication management device, the database storing, respectively for a plurality of separate operators or service providers comprising one operator or one service provider associated with the at least one second communication management device, information on the risk of non-compliance with the confidentiality of communication data.

8. The method of claim 7, wherein the first communication management device requests the transmission of the at least one risk indicator by the database, independently of the at least one communication.

9. The method of claim 1, wherein the at least one risk indicator is transmitted automatically by a database which is independent of the at least one second communication management device, when an update of the database is executed, the database storing, respectively for a plurality of separate operators or service providers comprising one operator or one service provider associated with the at least one second communication management device, information on the risk of non-compliance with the confidentiality of communication data.

10. A signal for managing at least one communication between a first communication apparatus and at least one second communication apparatus used respectively on separate communication networks, managed respectively by a first communication management device and at least one second communication management device, the signal transmitted during an exchange phase with the at least one second communication management device, and comprising representative information for the capacity of the at least one second communication apparatus and at least one risk indicator for non-compliance, by the at least one second communication management device, with the confidentiality of data associated with the at least one communication.

11. A device for managing at least one communication between a first communication apparatus and at least one second communication apparatus used respectively on separate communication networks, managed respectively by the communication management device and at least one second communication management device, the communication management device configured to:
acquire at least one risk indicator for non-compliance with the confidentiality of data associated with the at least one communication; and
transmit the at least one risk indicator to the first communication apparatus.

12. A communication apparatus configured to communicate with at least one second communication apparatus, the communication apparatuses being used respectively on separate communication networks, managed respectively by the communication management device of claim 11 and by at least one second communication management device, wherein the communication apparatus is configured to receive and process at least one risk indicator for non-compliance with the confidentiality of data associated with the at least one communication.

13. The communication apparatus of claim 12, reception and processing is activated during an exchange phase with said at least one second communication management device, the apparatus receives a signal comprising representative information for the capacity of the at least one second communication apparatus and the at least one risk indicator for non-compliance with the confidentiality of data associated with the at least one communication.

14. The communication apparatus of claim 12, wherein the apparatus is further configured to block and/or unblock the establishment of communication with the second communication apparatus, the blocking and/or unblocking being activated as a function of a value of said at least one risk indicator.

15. A non-transitory computer readable medium having stored thereon instructions which, when executed by a processor, cause the processor to perform, the method of claim 1.
